(19) United States
(12) Patent Application Publication
(10) Pub. No.: US 2001/0049818 A1
(43) Pub. Date: Dec. 6, 2001

(54) Partitioned code cache organization to exploit program locallity

(76) Inventors: Sanjeev Banerjia, Cambridge, MA (US); Evelyn Duesterwald, Somerville, MA (US); Vasanth Bala, Sudbury, MA (US)

Correspondence Address: HEWLETT-PACKARD COMPANY, Intellectual Property Administration, P.O. Box 272400, Fort Collins, CO, 80527-2400, US

(21) Appl. No.: 09/755,389

(22) Filed: Jan. 5, 2001

Related U.S. Application Data
(60) Provisional application No. 60/184,624, filed on Feb. 9, 2000.

(51) Int. Cl. G06F 9/45

(52) U.S. Cl. 717/9

(57) ABSTRACT

A method for operating a code cache in a dynamic instruction translator, comprising the steps of: storing a plurality of translations in a cold partition in a cache memory; maintaining a different associated counter for each of a plurality of translations in the cold partition of the cache memory; incrementing or decrementing the count in the associated counter each time its associated translation is executed; and moving the translation to a hot partition in the cache memory if the count in the associated counter reaches a first threshold value.

### RELATED APPLICATION

This application claims priority to provisional U.S. application Ser. No. 60/184,624, filed on Feb. 9, 2000, the content of which is incorporated herein in its entirety.

### FIELD OF INVENTION

The present invention relates generally to a Code Cache organization that transparently increases the performance of a dynamic translation system, and more particularly, to a code cache organization that increases performance through the selective placement of translations within the code cache.

### BACKGROUND OF THE INVENTION

Dynamic emulation is the core execution mode in many software systems including simulators, dynamic translators, tracing tools and language interpreters. The capability of emulating rapidly and efficiently is critical for these software systems to be effective. Dynamic caching emulators (also called dynamic translators) translate one sequence of instructions into another sequence of instructions which is executed. The second sequence of instructions are ‘native’ instructions—they can be executed directly by the machine on which the translator is running (this ‘machine’ may be hardware or may be defined by software that is running on yet another machine with its own architecture). A dynamic translator can be designed to execute instructions for one machine architecture (i.e., one instruction set) on a machine of a different architecture (i.e., with a different instruction set). Alternatively, a dynamic translator can take instructions that are native to the machine on which the dynamic translator is running and operate on that instruction stream to produce an optimized instruction stream. Also, a dynamic translator can include both of these functions (translation from one architecture to another, and optimization).

A traditional emulator interprets one instruction at a time, which usually results in excessive overhead, making emulation practically infeasible for large programs. A common approach to reduce the excessive overhead of one-instruction-at-a-time emulators is to generate and cache translations for a consecutive sequence of instructions such as an entire basic block. A basic block is a sequence of instructions that starts with the target of a branch and extends up to the next branch.

Caching dynamic translators attempt to identify program hot spots at runtime and use a code cache to store translations of those hot portions of the program. Subsequent execution of those portions can use the cached translations, thereby reducing the overhead of executing those portions of the program. “Hot” portions of the program are those that are expected to represent a significant portion of the program execution time; typically, these are frequently executed portions of the program, such as certain loops.

Accordingly, instead of emulating an individual instruction at some address x, an entire basic block is fetched starting from x, and a code sequence corresponding to the emulation of this entire block is generated and placed in a translation cache. See Bob Cmelik, David Keppel, “Shade: A fast instruction-set simulator for execution profiling,” Proceedings of the 1994 ACM SIGMETRICS Conference on Measurement and Modeling of Computer Systems. An address map is maintained to map original code addresses to the corresponding translation block addresses in the translation cache. The basic emulation loop is modified such that prior to emulating an instruction at address x, an address look-up determines whether a translation exists for the address. If so, control is directed to the corresponding block in the cache. The execution of a block in the cache terminates with an appropriate update of the emulator's program counter and a branch is executed to return control back to the emulator.

Thus, caching dynamic translators use a code cache to keep native translations of frequently executed code, thereby reducing system overhead. The standard approach used with a code cache is to treat the entire code cache memory as a homogeneous region of memory. In this regard, see the Cmelick and Keppel paper noted above.

### SUMMARY OF THE INVENTION

Briefly, the present invention comprises, in a first embodiment, a method for operating a code cache in a dynamic instruction translator, comprising the steps of: storing a plurality of translations in a cold partition in a cache memory; maintaining a different associated counter for each of a plurality of translations in the cold partition of the cache memory; incrementing or decrementing the count in the associated counter each time its associated translation is executed; and moving the translation to a hot partition in the cache memory if the count in the associated counter reaches a first threshold value.

In a further aspect of the invention, the hot partition is contiguous and disjoint from the cold partition in the cache memory.

In a further aspect of the present invention, the maintaining an associated counter step comprises maintaining counters in a data structure external to the cache memory.

In a yet further aspect of the present invention, the incrementing or decrementing step includes the step of at least temporarily delinking blocks of translations stored in the cold partition so that control exits the cache memory in order to perform the incrementing or decrementing.

In a further aspect of the present invention, the maintaining within the cache memory an associated counter step comprises maintaining one of the associated counters for each entry point into a plurality of the translations in the cold partition of the cache memory.

In a yet further aspect of the present invention, the maintaining an associated counter step comprises logically embedding update code on an arc between two translations.

In a further aspect of the invention, the maintaining an associated counter step comprises maintaining one of the associated counters for each machine cache line in an associated microprocessor.

In a further aspect of the present invention, the translation moving step comprises sampling a plurality of the associated counters on an intermittent basis to determine if the count therein has reached the threshold value.

In a further aspect, the present invention comprises the steps of: determining if a number of hot translations in the hot partition of the cache memory exceeds a second threshold value; and if the number of the hot translations exceeds the second threshold value, then expanding the size of the hot partition in the cache memory by adding thereto an expansion area contiguous to the hot partition. This may also include the step of removing all cold translations from the expansion area and storing the removed translations in the cold partition.

In a further embodiment of the present invention, a system is provided for a code cache in a dynamic instruction translator, comprising: a cache memory; a cold partition and a hot partition in the cache memory; logic for associating a different counter for each of a plurality of translations stored in the cold partition of the cache memory; logic for incrementing or decrementing the count in the associated counter each time its associated translation is executed; and logic for moving the translation to the hot partition in the cache memory if the count in the associated counter reaches a first threshold value.

In a yet further aspect of the present invention, a program product is provided, comprising: a computer usable medium having computer readable program code embodied therein for managing a cache memory comprising first code for storing a plurality of translations in a cold partition in a cache memory; second code for maintaining a different associated counter for each of a plurality of translations in the cold partition of the cache memory; third code for incrementing or decrementing the count in the associated counter each time its associated translation is executed; and fourth code for moving the translation to a hot partition in the cache memory if the count in the associated counter reaches a first threshold value.

### BRIEF DESCRIPTION OF THE DRAWINGS

FIG. 1 is a schematic block diagram of dynamic translator in which the present invention may be implemented.

FIG. 2 is a schematic block diagram of a flowchart of a preferred embodiment of the present invention.

### DETAILED DESCRIPTION OF THE PREFERRED EMBODIMENTS

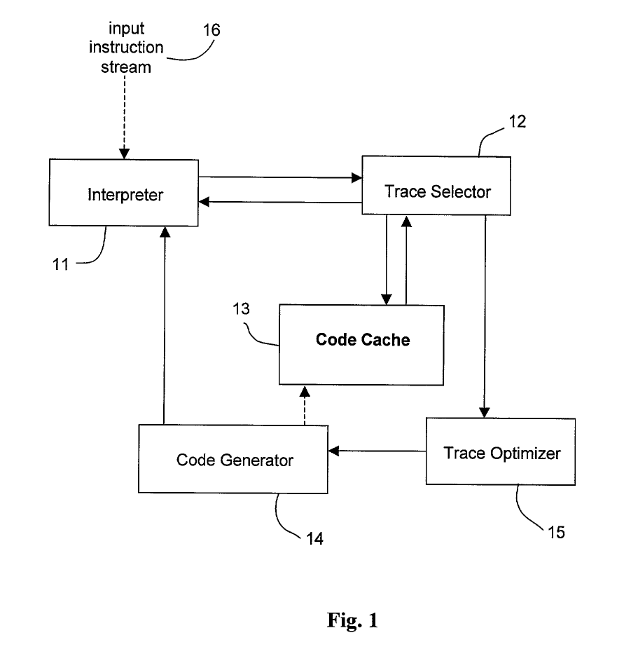

Referring to FIG. 1, an example context for the present invention is provided. FIG. 1 illustrates a dynamic translator that includes an interpreter 11 that receives an input instruction stream 16. This “interpreter” represents the instruction evaluation engine. It can be implemented in a number of ways (e.g., as a software fetch—decode—eval loop, a just-in-time compiler, or even a hardware CPU).

In one implementation, the instructions of the input instruction stream 16 are in the same instruction set as that of the machine on which the translator is running (native-to-native translation). In the native-to-native case, the primary advantage obtained by the translator flows from dynamic optimization that the translator can perform. In another implementation, the input instructions are in a different instruction set than the native instructions. As used in this application, the term “translation” refers to a dynamically generated code fragment whether or not instructions in that fragment have been translated, optimized, or otherwise changed.

A trace selector 12 is provided that identifies instruction traces to be stored in the code cache 13. The trace selector is the component responsible for associating counters with interpreted program addresses, determining when a “trace” that should be stored is detected, and then growing that trace.

After the interpreter 11 interprets a block of instructions, control is passed to the trace selector 12 so that it can select traces for special processing and placement in the cache. The interpreter—trace selector loop is executed until one of the following conditions is met: (a) a cache hit occurs, in which case control jumps into the code cache, or (b) a desired start-of-trace is reached.

When a start-of-trace is found, the trace selector 12, then begins to grow the trace. When the complete trace has been selected, then the trace selector, in one embodiment, may invoke a trace optimizer 15. The trace optimizer is responsible for optimizing the trace instructions for better performance on the underlying processor. After optimization is completed, the code generator 14 emits the trace code into the code cache 13 and returns to the trace selector 12 to resume the interpreter—trace selector loop.

The present invention, in one aspect, relates to the partition of the code cache into disjoint regions of memory, and then storing translations into a specific partition of the code cache based on the frequency of execution of the translation. By tracking the execution frequency of each translation, the code cache can obtain canonical information about which translations are executed the most frequently. The code cache can then use this information, along with a “hot threshold” to classify all translations into a plurality of different sets, based on their frequency of execution. The present invention will be described in the context of two partitions and a single hot threshold, H, for ease of explanation. However, it should be clear to one skilled in the art that two or more different thresholds could be provided in order to create three or more separate partitions in the code cache, with each partition storing translations in a different non-overlapping range of execution frequencies.

In the example used for ease of explanation to describe the present invention, the cold cache is described using two partitions, the cold partition and a hot partition. In a preferred embodiment, the hot partition should be a contiguous region within the code cache. The cold cache partition may, by way of example, surround this hot partition or be adjacent to this hot partition. Translations whose execution frequencies exceed the hot threshold, H, belong to the set of hot translations and are stored in the hot partition. All other translations belong to the set of cold translations, and are stored in the cold partition of the code cache. This two-level classification is used to guide the code cache placement decisions. Hot and cold translations are placed into disjoint areas of memory within the bipartitioned (or split) code cache. The placement decision is transparent to the remainder of the dynamic translator or other application, since it is encapsulated within the code cache logic, i.e., it is completely within the domain of the code cache manager, so that the remainder of the dynamic translator sees the code cache as a single piece of memory.

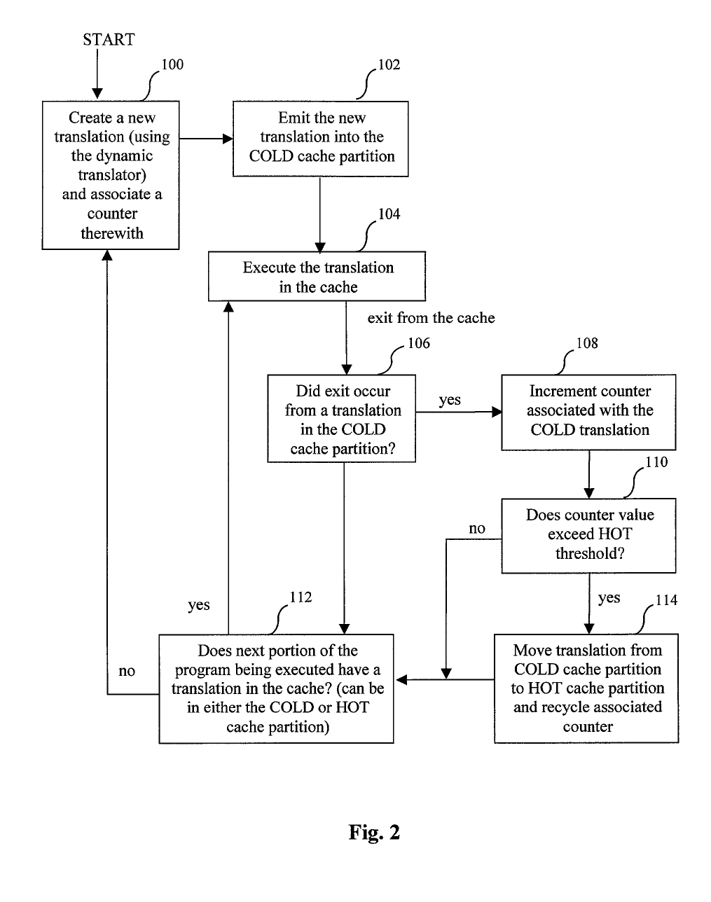

Referring now to FIG. 2, there is shown a flowchart of a preferred embodiment of the operation of the present invention. New translations are created using standard techniques in block 100 for a program being translated. All new translations created in block 100 are considered to be cold translations. Accordingly, block 100 also associates a counter with each such new translation. (The counter associated with a given translation is to be incremented/decremented each time that particular translation is executed, as discussed below.) The control of the code cache organization program then moves to block 104, wherein the new translation is stored in the cold partition of the cache.

The translation is then executed in block 104. When control exits from the translation that was executed in the code cache, typically via a branch of some type, it moves to block 106.

In block 106, control determines if the exit from the cache was from a cold translation in the code cache. Information associated with the exit branch at the time the translation code was generated, which, by way of example, may be stored in a lookup table, allows control to determine which cache partition it currently belongs to. This information is updated if the action in block 114 is performed.

The execution of the code cache organization program then moves to block 108, which operates to increment or decrement the associated counter assigned above, every time its particular translation is executed.

The execution of the cache organization program then moves to block 110 which compares the execution count value held in the counter which has just been incremented/decremented with a hot threshold, H, to determine whether the counter value exceeds the hot threshold H. If the execution count value for the particular counter has not exceeded the hot threshold, H, then the execution for the cache organization program moves to block 112 to determine if the next portion of the program being translated and executed has a translation in the code cache. If the answer is NO, then the control moves to block 100, wherein a new translation is created using the dynamic translator, and the cache organization program begins a new cycle. If the answer is YES, that the next translation is in the code cache, then control moves to block 104 to execute that translation in cache.

Alternatively, if the execution count value for a particular counter exceeds a hot threshold, H, then the execution moves to block 114, wherein the translation associated with that counter is moved to the hot partition of the code cache.

Accordingly, it can be seen that translations are initially placed in the cold partition of the cache, and then migrated or promoted from the cold partition to the hot partition, with the migration operating in a pipelined, assembly-line fashion. It can be seen that this migration between partitions can easily operate with three or more partitions. Note that migration has been previously applied in generational garbage collection; a data object that has survived long enough is moved from a “youngest” memory pool to an “older” memory pool. The difference between the generational garbage collection and a partitioned code cache is that the garbage collection operation deals with data items and the code cache deals with instruction translations. Furthermore, in the case of garbage collection of data objects, accesses to the data objects is continuously tracked so that they may move from one pool to another several times during the execution of the program. The overhead of doing such continuous monitoring is prohibitive when the objects are the program's instructions and not its data. In the method described here, only executions of the translations in the cold cache partition are monitored. Once a translation moves into the hot cache partition, its execution is not monitored.

The code cache organization program can track execution frequencies by maintaining a dedicated counter for each cold translation (any translation which can be promoted to a higher level partition based on its execution frequency). Note that the hottest translations do not require counters as they cannot be promoted to a higher partition. There are multiple ways of maintaining a dedicated counter for each cold translation. By way of example, for a software cold cache implementation, a counter can be maintained in a data structure external to the memory space where translations are stored. Note that for this type of implementation, it is necessary that the code cache logic program gain control prior to every execution of a cold translation (regardless of the entry point into the translation). Accordingly, it will be necessary to disable any links between blocks in a cold translation so that the cold cache organization program can gain control and use this control point to implement an execution counter associated with one of the blocks in the translation.

Alternatively, a software cold cache implementation could be provided wherein associated counter incrementation could be performed during in-cache execution. For such an implementation, an execution counter would be required for every entry point into the cold translation. If each translation is a single entry code region, then one counter would be required per translation. The counter for this alternative software implementation could be embedded as a data word just prior to the beginning of the translation. In this regard, the code for incrementing the counter could be embedded at the top of every cold cache code block. A control transfer to a cold translation requires that either the translation from which control will transfer—the predecessor—or the translation to which control will transfer—the successor—orchestrate an update of the successors counter. This can be achieved by logically embedding the update code on the arc between the two translations. In this regard, when two translations are linked within the code cache, after completion of the execution of the first translation, the execution would jump to this increment code (the arc), which would cause an incrementation of the appropriate counter, and from that code it would then jump to translation 2. Note that the incrementation code can be physically located anywhere within the code cache, though it is convenient to locate it within the cold partition since the successor is within the cold partition.

In yet a further implementation of this counting operation, a hardware counter can be maintained for every machine cache line in the associated microprocessor. For every read hit in the code cache for a given translation, the counter associated with that particular cache line would be updated.

Note that for all three implementation options, the migration operation can be implemented by sampling all of the counters on an intermittent basis, and at that time promoting all translations whose count exceed the hot threshold, H, to the hot partition in the cache.

Note that individual translations can be stored as fixed or variable size units. Either approach is compatible with a partitioned organization, although whichever grouping experiences a lower degree of locality may benefit from the partitioned organization. The sizes of the partitions do not have to be fixed. In fact, fixed size partitions can impose an artificial restriction on the number of bytes of each type of translation that the entire code cache can hold. When the sizes of the partitions are not fixed, the code cache is able to adapt to the behavior of the dynamic translator for different input programs. For example, a program that creates a high percentage of cold translations will not be constricted from using any of the available cold cache space that would otherwise have been pre-allocated for hot translations only.

However, note that there may be situations where a pre-allocation for the hot partition may be advantageous. When such a pre-allocation of the hot partition is utilized, then it may be necessary to expand the hot partition when the number of hot translations exceeds a pre-determined threshold. In this respect, the cache organization program would include a step of determining if a number of hot translations in the hot partition of the cache memory exceeds a second threshold value. If the number of hot translations does exceed this second threshold value, then expanding the size of the hot partition in the cache memory by adding thereto an expansion area contiguous to the hot partition. This operation might further include the step of removing all cold translations from the expansion area and storing these removed cold translations into the cold partition.

It should be noted that the effect of spreading hot translations over an entire code cache, as is practiced in the prior art, is at odds with the need for spatial locality that is desirable within a cache. In this regard, it is particularly advantageous to have block locality for a set of hot blocks in a loop. In this situation, when blocks are linking to other blocks within the code cache, without exiting the code cache, it is desirable for those linked blocks to be relatively close to another.

Accordingly, the partitioned organization of the present invention is -designed to store translations in separate, disjoint areas of the code cache based on the frequency of execution characteristics of the various translations. This organization within the code cache leads to several positive effects, all arising from an increase in locality: a reduction in instruction cache conflict misses; a reduction in page faults; and a reduction in TLB pressure. A partitioned code cache in accordance with the present invention can be integrated into a caching dynamic translator in a seamless, transparent fashion.

The foregoing has described a specific embodiment of the invention. Additional variations will be apparent to those skilled in the art. For example, although the invention has been described in the context of a dynamic translator, it can also be used in other systems that employ interpreters or just-in-time compilers. Further, the invention could be employed in other systems that emulate any non-native system, such as a simulator. Thus, the invention is not limited to the specific details and illustrative examples shown and described in this specification. Rather it is the object of the appended claims to cover all such variations and modifications as come within the true spirit and scope of the invention.

What is claimed is:

1. A method for operating a code cache in a dynamic instruction translator comprising the steps of:
storing a plurality of translations in a cold partition in a cache memory;
determining whether a translation that has been stored in the cold partition is hot; and
moving the translation to a hot partition in the cache memory when a translation has been determined to be hot.

2. A method as defined in claim 1, wherein the step of determining whether a translation is hot comprises:
maintaining a different associated counter for each of a plurality of translations in the cold partition of the cache memory;
incrementing or decrementing the count in the associated counter each time its associated translation is executed; and
concluding the determination that a translation is hot if the count in the associated counter reaches a first threshold value.

3. A method as defined in claim 1, wherein said hot partition is contiguous and disjoint from said cold partition in said cache memory.

4. A method as defined in claim 2, wherein said maintaining an associated counter step comprises maintaining counters in a data structure external to said cache memory.

5. A method as defined in claim 4, further comprising the step of at least temporarily delinking blocks of translations stored in said cold partition so that control exits the cache memory in order to perform the incrementing or decrementing step.

6. A method as defined in claim 2, wherein said maintaining within said cache memory an associated counter step comprises maintaining one of said associated counters for each entry point into a plurality of the translations in said cold partition of the cache memory.

7. A method as defined in claim 2, wherein said maintaining an associated counter step comprises logically embedding update code on an arc between two translations.

8. A method as defined in claim 2, wherein said maintaining an associated counter step comprises maintaining one of said associated counters for each machine cache line in an associated microprocessor.

9. A method as defined in claim 2, wherein said translation moving step comprises sampling a plurality of said associated counters on an intermittent basis to determine if the count therein has reached said threshold value.

10. A method as defined in claim 1, further comprising the steps of:
determining if a number of hot translations in said hot partition of said cache memory exceeds a second threshold value; and
if said number of said hot translations exceeds said second threshold value, then expanding the size of said hot partition in said cache memory by adding thereto an expansion area contiguous to said hot partition.

11. A method as defined in claim 10, further comprising the step of removing all cold translations from said expansion area and storing said removed translations in said cold partition.

12. A method as defined in claim 2, wherein the maintaining an associated counter step comprises maintaining an associated counter for all translations in the cold partition of the cache memory.

13. A system for a code cache in a dynamic instruction translator comprising:
a cache memory;
a cold partition and a hot partition in said cache memory;
logic for determining whether a translation that has been stored in the cold partition is hot; and
logic for moving the translation to a hot partition in the cache memory when a translation has been determined to be hot.

14. A system as defined in claim 13, wherein the logic for determining whether a translation is hot comprises:
logic for associating a different counter for each of a plurality of translations stored in the cold partition of the cache memory;
logic for incrementing or decrementing the count in the associated counter each time its associated translation is executed; and
logic determining if the count in the associated counter reaches a first threshold value.

15. A system as defined in claim 13, wherein said hot partition is contiguous and disjoint from said cold partition in said cache memory.

16. A system as defined in claim 14, wherein said counters are maintained in a data structure external to said cache memory.

17. A system as defined in claim 16, wherein said incrementing or decrementing logic further comprises logic for at least temporarily delinking blocks of translations stored in said cold partition so that control exits the cache memory in order to perform the incrementing or decrementing of the count.

18. A system as defined in claim 14, wherein said logic for associating counters comprises logic for maintaining one of said associated counters for each entry point into a plurality of the translations in said cold partition of the cache memory.

19. A system as defined in claim 14, wherein said logic for moving the translation comprises logic for sampling a plurality of said associated counters on an intermittent basis to determine if the count therein has reached said threshold value.

20. A system as defined in claim 13, further comprising:
logic for determining if a number of hot translations in said hot partition of said cache memory exceeds a second threshold value; and
if said number of said hot translations exceeds said second threshold value, logic for expanding the size of said hot partition in said cache memory by adding thereto an expansion area contiguous to said hot partition.

21. A system as defined in claim 20, further comprising:
logic for removing all cold translations from said expansion area and storing said removed translations in said cold partition.

22. A system as defined in claim 14, wherein the logic for associating a counter step comprises logic for maintaining an associated counter for all translations in the cold partition of the cache memory.

23. A program product, comprising a computer usable medium having computer readable program code embodied therein for directing a computer to manage a cache memory by:
storing a plurality of translations in a cold partition in a cache memory;
determining whether a translation that has been stored in the cold partition is hot; and
moving the translation to a hot partition in the cache memory when a translation has been determined to be hot.
